(19) United States
(12) Patent Application Publication
(10) Pub. No.: US 2009/0049384 A1
(43) Pub. Date: Feb. 19, 2009

(54) Computer desktop multimedia widget applications and methods

(76) Inventor: Frank Yau, Redwood City, CA (US)

Correspondence Address: FRANK YAU, 258 NICE COURT, REDWOOD CITY, CA, 94065, US

(21) Appl. No.: 12/228,492

(22) Filed: Aug. 13, 2008

Related U.S. Application Data
(60) Provisional application No. 60/964,626, filed on Aug. 13, 2007.

(51) Int. Cl. G06F 3/00

(52) U.S. Cl. 715/716

(57) ABSTRACT

Methods of web connected computer desktop multimedia widget applications provide users to author and host interactive multimedia content with processes and features to enhance intuitive, seamless user experience, and interactive functions without web browser.

### RELATED APPLICATIONS

This application claims the priority of U.S. provisional patent application Ser. No. 60/964,626 filed on Aug. 13, 2007.

### FIELD OF THE INVENTION

The present invention relates to computer desktop multimedia widget applications that provide an openly accessible peer to multi-peers platform for any users to author and host interactive multimedia content for intended playback by the masses, and more particularly in methods and processes that enhance intuitive and seamless user experience and interactive functions all without traditional web browser applications over the web.

### BACKGROUND OF THE INVENTION

Multimedia content such as digital video, audio, rendering, and interactive web services have been relying on web browser applications to feature and access to content sources over the internet to playback streaming and on-demand delivery of such contents. With desktop multimedia widget applications, the multimedia content would not need to be accessed and playback over the cumbersome navigation of web browser to access and playback the content via the internet. Desktop multimedia widget applications can take the place or provide more customized functions and user interface than a web browser with more specific, customized, and intuitive controls and presentations in interactive user interface especially for direct access or preferred content.

Desktop multimedia widget applications and methods enable direct access to the relevant content via the internet without the need of web browser to provide even greater capabilities and enhanced user experience on multimedia information and entertainment in digital rendering on a computer or mobile computing device.

Advantages and uses for such desktop multimedia widget applications and methods will become apparent to those skilled in the art once they have knowledge of the present disclosure.

### SUMMARY OF THE INVENTION

In accordance with the present invention, desktop multimedia widget applications and methods enable open web access to host and deliver multimedia content by a peer host to multi-peer viewers platform, and more particularly in digital video and audio streaming, broadcast, and on-demand playback as well as digital rendering and interactive functions all without traditional web browser applications.

Additionally, the desktop multimedia widget applications and methods provide more functional and creative interactive user interface and direct content access via the internet without the cumbersome and restrictive web browser functions and user interface.

The present invention also illustrates that the desktop multimedia widget applications can easily setup by the peer host in authoring and hosting content with intuitive user interface with desired functionality to feature content for access by intended multi-peer viewers with built-in privacy and content security. The access of content is determined by unique user identification of the host and the intended multi-peer viewers.

Purity of desktop multimedia widget applications can be employed by intended multi-peer viewers with purity of interconnections to the content sources featured by peer-host(s) over the web simultaneously at anytime and anywhere.

The desktop multimedia widget applications and methods are applicable for any electronic computing display devices that are stationary or mobile such as, but limited to, personal computers, workstation computers, industrial computers, special purpose computing devices, portable or handheld computing display devices, smart phones, IPTV, Internet TV sets, or TV set-top boxes.

Accordingly, the present invention provides the desktop multimedia widget applications and methods with vast varieties of optional multimedia features and functions that can be employed by the peer host users to feature and host individual or dedicated contents for intuitive and enhanced user experience and enjoyment.

Other objects, advantages and novel features of the present invention will become apparent from the following detailed description of the invention when considered in the conjunction with accompanying drawings.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1 is a pictorial representation of desktop multimedia widget applications overview according to the present invention.

FIG. 2 is a pictorial representation of desktop multimedia widget applications with widget user interface according to the present invention.

FIG. 3 is a pictorial representation of desktop multimedia widget applications suite according to the present invention.

FIG. 4 is a pictorial representation of desktop multimedia widget application with desktop host authoring user interface widget for seamless and intuitive content hosting authoring according and to the present invention.

FIG. 5 is a pictorial representation of desktop multimedia widget applications with multimedia widget application software and access distributions according to the present invention.

FIG. 6 is a pictorial representation of desktop multimedia widget applications with content delivery network architecture according to the present invention.

### DETAILED DESCRIPTION OF THE INVENTION

Referring now descriptively to the drawings, the attached figures illustrate the methods of desktop multimedia widget applications:

The following description of the preferred embodiment of the invention is not intended to limit the scope of the invention but rather to enable any person skilled in the art to make and use this invention.

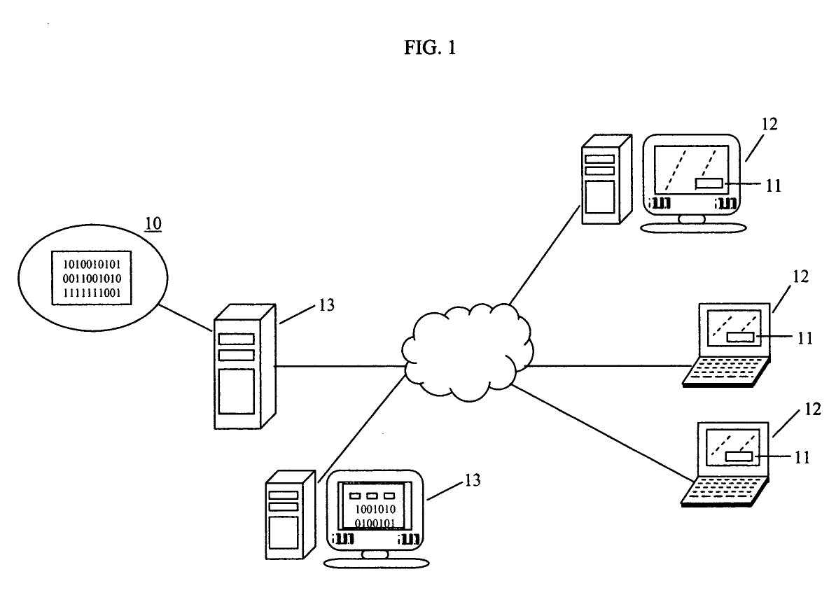

As shown in FIG. 1, the present invention is a desktop multimedia widget application 10 with a widget user interface 11 to enable selections and playback of streaming, on-demand, or interactive digital rendering on any computer desktops 12 by intended peer-viewers accessing content and interactive digital rendering from a host server managed by a peer-host 13 over the internet or an intranet.

The desktop multimedia widget application 10 is designed for auto installation and configuring for network access over the internet or intranet to the portal server 13 for content access and database interface was well as periodically software update and administrative contacts.

The desktop multimedia widget application 10 is capable to function with various suitable video and audio player software applications or codec for the best playback requirements on various suitable digital video and audio formats, resolutions, frame rates, and data rates; the video player can also provide automatic frame buffering for smooth playback when only low bandwidth connectivity is available.

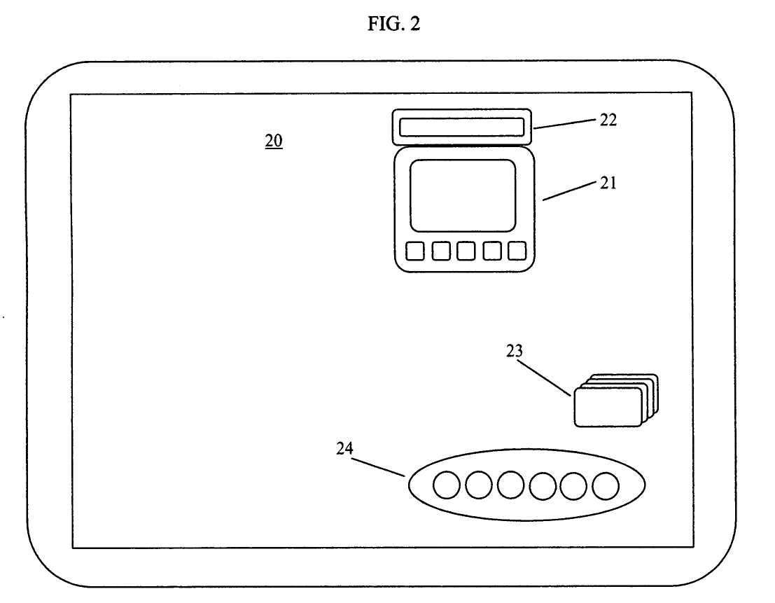

As shown in FIG. 2, the present invention is a computer desktop multimedia widget application user interface 20 with user interface widget 24 are described and illustrated in the present invention.

Graphical presentation of the desktop multimedia widget application user interface 20 refers to as skin which can be selected and changed from different versions available for download from a portal or customized locally by loading an image file as an overlay onto the existing graphical presentation.

Media player widget or multimedia widget application 21 can be re-sized by viewers either to prefixed dimensions or flexible size desired by the viewer. Additional message display widget 22 can be provided for information or advertising options.

The user interface widget 24 and rolodex widget 23 can display available widget selections and list of host accounts or channels with respective icon, photo or logo representation of the peer hosts. Available host accounts can also be listed and accessed without the rolodex widget 23 instead directly accessed from a multimedia widget application 21 through its embedded control panel or preference page when selected.

User interface widget 24 displays alerts, messages, and enable launches of the available functions. Either graphical buttons or tabs are listed on the user interface widget 24 for accessing and displaying different functions which could be launched at the same time or separately. Alternatively, the user interface widget 24 functions and control could be embedded on the multimedia widget application 21 directly.

The user interface widget 24 shall provide alert when an intended host is offline. Graphical illustration of the user interface widget 24 can be translucence when not active.

Customized user interface widget 24 and multimedia widget applications 21 with variety of skins shall be available for selections by users to suit in usages with personal computer to smaller display of portable devices.

A desktop multimedia widget application user interface 20 can provide different language selections as well as automatic language text translation function.

A desktop multimedia widget application 10 provides usage reporting, check-in functions, and also enables pushing new interface application software when available.

A desktop multimedia widget application user interface 20 may contain a rolodex widget 23 and favorite list with peer host profile information of available widgets for selections and searches. Alternatively, the available peer host accounts can be searched and selected from a function or a page embedded within the multimedia widget application 21.

A desktop multimedia widget application 10 software employs suitable software such as, but not limited to, MySQL, JavaScript, Java, C++, streaming server as well as graphical illustration and rendering software with codec to playback and display various digital content formats and manage database as required.

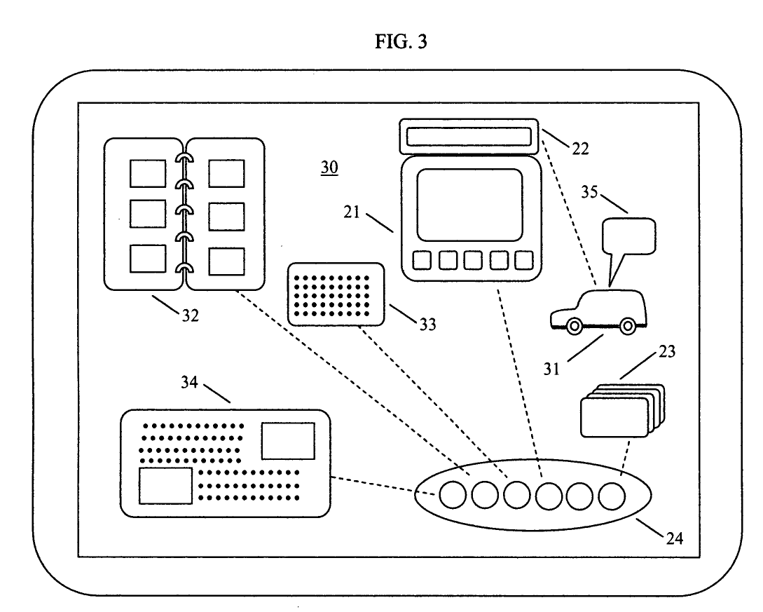

As shown in FIG. 3, the present invention is a desktop multimedia widget applications suite 30 with a desktop user interface widget 24 launches multimedia widget applications 21, 32, 33, and or 34 with various functions and intended usages with the respective skins and controls such as, but not limited to, TV, radio, notepad, sticky notes, message board, photo album, video player, book, magazine, newspaper, photo-frame, schedule, contact list, invitation, Personal Media Book, and rolodex graphical presentations. Alternatively, the desktop widget multimedia applications suite 30 or its respective multimedia widget applications 21, 32, 33 or 34 can be launched from an icon or program list on the desktop or other associated widget applications without the dedicated user interface widget 24.

Purity of multimedia widget applications 21 can be launched on the desktop with interactive and web connected functions that may or may not be interdependent or provide related functions.

Multimedia widget applications 21, 32, 33, or 34 can contain multiple functions or these functions combined into a single multimedia widget application with sections illustrated such as, but not limited to, blog (text log or notes), schedule (calendar), contact list, photo album, sticky notes, video etc. . . . where these sections contain graphical tabs that a user can click on to brings the rendering to the corresponding section with table of content or index listing available content for access or links. One example of such usage of the combined multimedia widget application 32, but not limited to, is a Personal Media Book. The Personal Media Book would become a self-contained multimedia widget application 32 but could still launch other related multimedia widget applications such as a video player widget 21 for video playback. Furthermore, page flipping in content rendering by clicking a designated area or corner of a page in multimedia widget applications 21, 32, 33, or 34 such as publications, photo albums, Personal Media Book are an intuitive enhancement of user experience.

Once the user is in the particular section with related content, further interactivity would render the intended content such as, but not limited to, text, images, video, and audio presented in the intended graphical representations. Optionally, music files, internet radio stations, or music channels could be linked to provide music programming as a feature. Photo could be enlarged for better viewing, text description would appear, and voice or audio caption playback available when a user run the computer mouse over the photo object in a multimedia widget application 21, 32, 33, or 34 while viewing. Tag of a content or page of a multimedia widget application 21, 32, 33, or 34 could also be generated and sent via email or sticky notes to another user for access to the tagged content where the tag could appear as a bookmark graphically when the content is accessed. The photos featured in the multimedia widget applications 21, 32, 33, or 34 can also be printed locally or remotely via an internet photo service.

The sticky notes featured in the multimedia widget application suite 30 is a web connected electronic messaging feature to communicate with other users who have the same access to the same account as a peer host or peer viewer. Text messages can be typed and left on a graphically illustrated sticky note area which could be enlarged when clicked on for ease of interactivity. The illustration would show the stacking of the sticky notes when multiple messages are left such as replies are left on the message. There are graphical controls to allow a user to view previous or next message in the sticky note stack.

The peer host or authorized users of the account associated with the multimedia widget applications suite 30 can manage, update, enter, load, add and delete content as well as profile and preferences as desired by accessing their multimedia widget applications suite 30 with a sign-in process. Authorized peer viewers would only be able to view and playback intended content when accessing the account; in some functions or occasions, the authorized peer viewers would be able to leave messages or contribute content in a limited basis.

Graphical effects for launching or closing these functions could be emphasized by the content flying or floating in or out of the desktop. User interface icon or illustrated object can be rendered in a lively standalone graphical object. Advertising or other desired graphical information could be featured as any desired or targeted object as a multimedia advertising widget 31 such as, but not limited to, a car in a standalone graphically illustrated 3D object on the desktop with interactive features and optional dialogue widget 35 and or audio for rendering. The multimedia advertising widget 31 can feature sponsor logos with interactive links to another widget or website.

A desktop multimedia widget applications suite 30 may be capable to bookmark content and playback so when restart on the same device or when moved to a different device, it could play and start at the same place.

A desktop multimedia widget applications suite 30 is capable to access video source over websites or web links to access video content and be able to playback over the media player widget 21 via a filter or format converter, if required, so it would display properly.

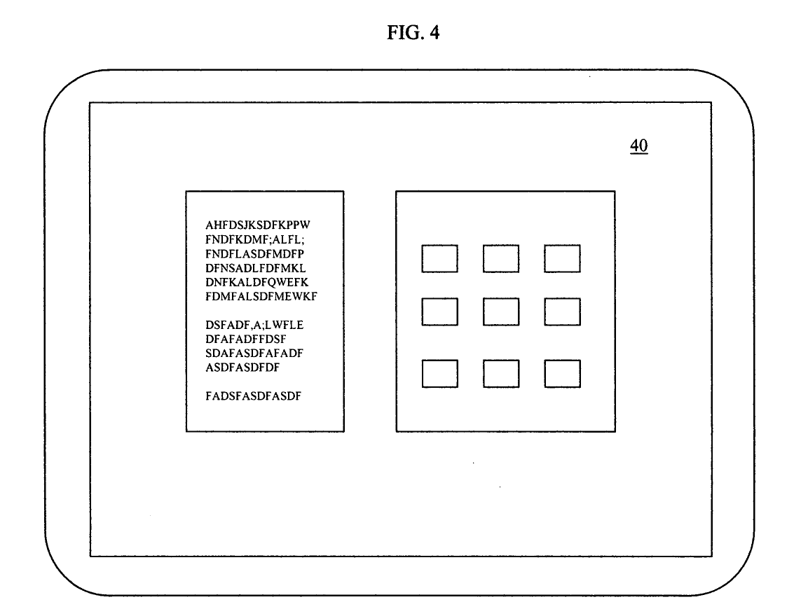

As shown in FIG. 4, the present invention is a desktop multimedia widget application user interface 20 with desktop host authoring user interface widget 40.

A peer host who is desired to feature interactive content to intended multi-peer viewers over the multimedia widget application suite 30 would set up a widget host account from a website or widget portal over the internet or intranet by initial sign up using an email address or widget message account and password for host access. A peer viewer is a user whose authorized access is only to view other peer host content in respective multimedia widget application suite 30. A peer viewer would sign-up for account similar to the peer host.

Peer-host would use the desktop host authoring user interface widget 40 to set up account profile and preferences, features and content for the intended multi-peer viewer accesses. During setup, the peer-host would be able to select between private, open-private, or public access for the intended multi-peer joining. Each peer-host or peer-viewer would have unique account identification.

When peer host is adding or loading new content, the multimedia widget application suite 30 enables authoring features or desktop host authoring user interface widget 40 that are seamless to the user in user interface where most of the editing, loading, adding, modifying, and deleting content operations are in either drag and drop or WYSIWYG.

Drag and drop a video file, for storage and playback as it's or encoded in a different format for storage playback locally on the computer or remotely on the server for streaming or on-demand playback, to a digital media disk illustrated icon on the multimedia widget application 30 provides an intuitive user experience for an otherwise complex process. The automated process would also insert a thumbnail image over the disk figure which links to an encoded video stored.

The drag and drop operation initiates a process behind the scene, that takes place on a server or the local computer, in copying and encoding a video file from a computer, camera, video camcorder, or other digital devices that contain the suitable video file for encoding or transferring to the designated storage location.

Video playback by clicking on the overlay thumbnail image, of the encoded video clip over a digital media disk like icon which is a graphical representation of a video disk, that contains a link to an encoded video file stored either locally on the computer or remotely at a web server. The original digital video clip is any suitable video formats from any digital cameras, camcorders, or video devices connected to the computer. The drag and drop operation enables a user graphically move the icon image of a desired video file from a source location to the disk icon destination on the multimedia widget application suite 30. Once the video file icon has been placed in the destination disk icon, a caption dialogue box would pop-up where a user can enter text for such as, but not limited to, title and description of the video. Once the caption information is entered and closed, the video would begin the transfer process from the source to the designated location (local computer or remote server via local network or internet) for the auto encoding process and or storage of the video file as it's, or encoded to another video format suitable to playback over the codec of the multimedia widget application suite 30.

There may be optional graphical indication or representation of the encoding process to remind the user while the process is taking place. Upon completion of the transfer or the encoding process, a thumbnail image developed from the video encoding process is digitally inserted as an overlay onto the destination disk icon of which may previously looked like a blank disk in an optional CD or DVD semi-transparent pocket image.

Voice captions can be added to image, photo, picture, video thumbnail files for enhanced interactivity experience when viewing these types of content. The voice files for the captions are recorded as, but not limited to, MP3, AIFF, WMA, QuickTime or any suitable audio file formats. These files can be drag and drop from the source location to the rendering location directly; in turn, behind the scene, the voice file is copied and stored in the designated location in the local storage or remotely at the content server.

A picture or photo image can be drag and drop from the source location to the multimedia widget application suite 30 directly; in turn, behind the scene, the rendering file is copied and stored in the designated location in the local storage or remotely at the content server.

Alternatively, the drag and drop process can be replaced by window files search and select process to locate and load the desired files with remaining behind the scene processes and features the same as described above.

Peer host can upload or update content files to either local storage on the computer or remote network content storage. Peer-host will determine the type of content to be available to hosting in the multimedia widget applications suite 30.

Peer-host authoring features can set the type of functionality available to be included or presented on the multimedia widget applications suite 30 that the intended multi-peer viewers would get; peer-host can add or reduce the functionality or type of content to be featured.

Within an established open-private peer group, any members or peer-viewers belonging to the group can leverage the listed peers in building a new peer group in the hosting relationships. Any peer viewers with an installed desktop multimedia widget application suite 30 can access any public designated content.

Users can install desired graphics such as, but not limited to, JPEG formatted file to enable customized graphical overlay with embedded modifiable functions to facilitate customized skins.

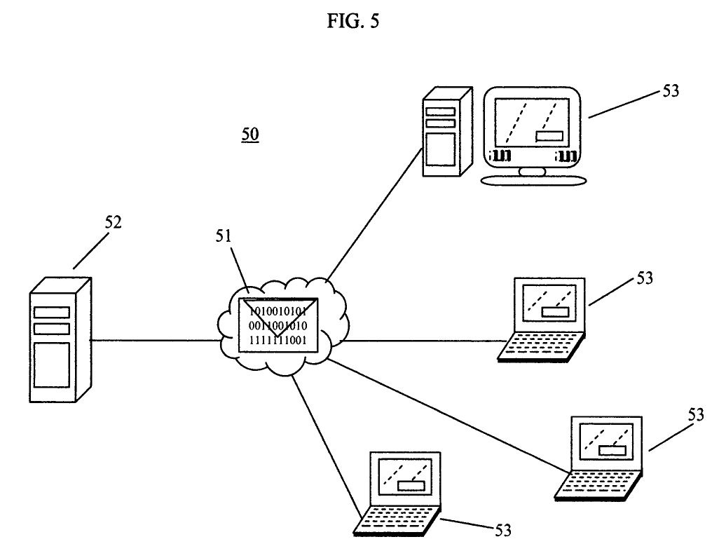

As shown in FIG. 5, the present invention is a desktop multimedia widget application 10 with multimedia widget application software and access distributions 50 containing unique identification of the host-peer account that can be sent via an invitation email 51 or widget message to other users for joining or installing multimedia widget application suite 30.

Widget messages 51 can be sent and received in private or broadcast mode depending on the host selections.

Available public, open-private, or private accounts would automatically be updated to the intended peer viewer rolodex widget 23 or embedded preference page contain profile information for access or search.

Once joined in, the peer viewer identification would be filed on database for the particular host; then the viewer can bring the multimedia widget applications suite 30 access to any computer platform with suitable operating system.

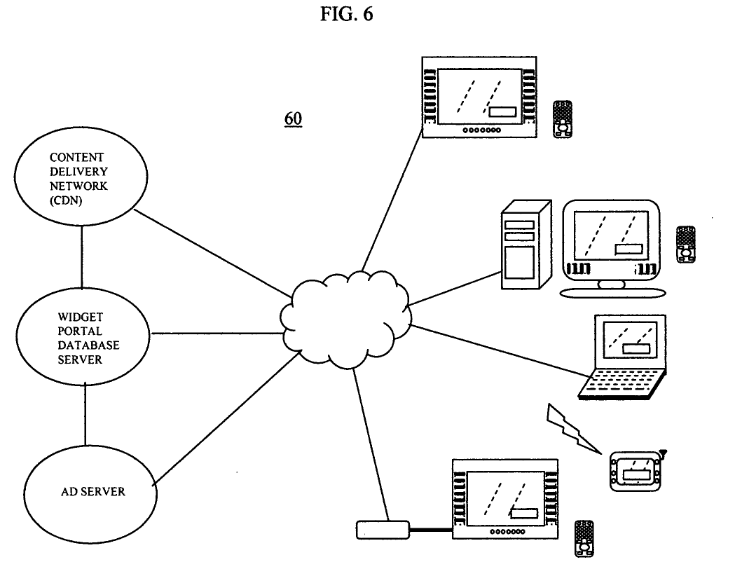

As shown in FIG. 6, the present invention is a desktop multimedia widget application 10 with content delivery network architecture 60 to deliver content where the content server and database can be resided on the same or different servers.

The multimedia widget application 10 utilizes the user signed up date and links in the peer grouping to map relationship tree and usage information to optimizing product placement, sponsorships, and advertisement. Widget will report pre-determined information including but limited to user ID and IP address periodically to web server for recording time access and duration for usage tracking.

Optional advertising server is to push advertising messages or content to be displayed on the advertising widget 31. Purity of advertising widgets 31 can be launched with predetermined time and duration complementing the multimedia widget applications suite 30 along with the content sequence as controlled by advertising management server and software.

Alternatively, content can be accessed without central server in a peer to peer network architecture with content stored locally at the peer host's computer or server so it would save bandwidth and gain faster access via the decentralized peer to peer network; yet for backup, a copy of the content could be loaded at the central server to be available for times when copies in peer network is not available.

Widget authoring database is resided with a hosting portal; however, the feature content can be located in a different portal or Content Delivery Network (CDN).

Even if the content is resided in third party storage such as content delivery network, the playback access authorization is controlled by the database server.

Optionally, video and audio playback is in play and trim mode so no content would be copied to the peer viewer computers.

Digital right management can be achieved by the media player widget 21 which only allows to playback video and audio content from specific servers, web portals, or host identifications.

Remote control can be employed to launch, navigate, or select functions with the multimedia widget applications suite 30 featured on computers, TV set-top-boxes, integrated IPTV sets, or Internet TV sets.

Host identification can be listed as channels with name and logo shown on favor-list or rolodex widget 23 as well as surfed with remote control devices.

Alternatively, widget message board can provide private or public electronic text or voice messages within the peer group which it is intended. The widget message board could also provide links with graphical icons to downloadable files posted on its host content storage site so the intended peer viewers can access and view or extract files when desired.

It is further intended that any other embodiments of the present invention that result from any changes in application or method of use or operation which are not specified within the detailed written description or illustrations contained herein yet are considered apparent or obvious to one skilled in the art that are within the scope of the present invention. Furthermore, as any person skilled in the art will recognize from the previous detailed description and from the figures, modifications and changes can be made to the preferred embodiment of the invention without departing from the scope of this invention.

I claim:

1. A web connected computer desktop multimedia widget application with methods to enable users in authoring to feature and host desired content without web browser comprising: language interface and translation, launching associated widgets, combining functions into a single widget, sticky notes or message board widget, voice captions for photo viewings, advertisement widgets, content bookmarking, auto video encoding process with thumbnail images, user relationship trees, digital right management content, and using remote control for channel surfing.

2. The method of claim 1, wherein the multimedia widget applications provide different language interface selections and or automatic language text translation functions.

3. The method of claim 1, wherein the multimedia widget applications can be launched by other associated multimedia widget applications.

4. The method of claim 1, wherein purity of multimedia widget applications can be launched on the desktop with interactive and web connected functions that may or may not be interdependent or provide related functions.

5. The method of claim 1, wherein the multimedia widget application features sticky notes to provide electronic text communications with other users on the web.

6. The method of claim 1, wherein purity of multimedia widget applications, each with a different function such as, but not limited to, TV, radio, notepad, sticky notes, message board, photo album, video player, book, magazine, newspaper, photo-flame, schedule, contact list, invitation, Personal Media Book, or rolodex where any of the listed functions can be combined into a single multimedia widget application with compartmented functional interfaces.

7. The method of claim 1, wherein the multimedia widget application enables voice or audio captions loaded with the picture or photo files for playback when viewed.

8. The method of claim 1, wherein the multimedia widget application enables updates, entries, loading, adding and deleting content as well as managing profile and preferences that are seamless to the users with intuitive user interface where most of the editing or authoring operations are either in drag and drop or WYSIWYG.

9. The method of claim 1, wherein the multimedia widget application features standalone multimedia advertising widget on the desktop to show advertising messages or 3D graphical objects with interactive features and optional dialogue widget and or audio as well as optional sponsor logos with interactive links to other widgets or websites.

10. The method of claim 1, wherein the multimedia widget application features bookmark for content and playback so when restart on the same device or when moved to a different device, it could play and start at the same place.

11. The method of claim 1, wherein the multimedia widget application features drag and drop operations to initiate an automatic process in copying and encoding video files from a computer, camera, video camcorder, or other digital devices that contain suitable video file for encoding or transferring to the designated storage locations for playback from links that feature thumbnail images of the encoded video file.

12. The method of claim 1, wherein the multimedia widget application inserts a thumbnail image, automatically upon completion of the video encoding process, with optional text dialogue over a video media disk figure icon which links to the encoded video stored.

13. The method of claim 1, wherein the multimedia widget application utilizes auto reporting of usage information along with user profiles and links in the peer groups to map relationship trees to optimizing product placement, sponsorships, and advertisement.

14. The method of claim 1, wherein the multimedia widget application features purity of complementary multimedia advertising widgets with pre-determined time and duration along with the content sequence as controlled by the advertising management software.

15. The method of claim 1, wherein the multimedia widget application provides digital right management by allowing content playback only from specific servers, web portals or host identifications.

16. The method of claim 1, wherein the multimedia widget application employs electronic remote control to launch, navigate, or select functions with the multimedia widget applications featured on TV set-top-boxes, integrated IPTV sets, or Internet TV sets.

17. The method of claim 1, wherein the multimedia widget application enables host identifications to be listed as content channels with names and logos shown on favor list, rolodex widget, or remote control devices.

18. The method of claim 1, wherein the multimedia widget application features a message board widget that provides private or public electronic text, voice messages, file transfers within the peer group which it is intended.

19. A Personal Media Book is a web connected desktop multimedia widget application with multiple functions that enable a user to author and host interactive multimedia content to share with intended viewers requiring an account sign-in process to access the combined multimedia widget with compartmented sections comprising: not limited to, blog (text log or notes), photo album, sticky notes, video, and music where these sections contain graphical tabs or page flip area that a user can click on to bring the rendering to the corresponding section may employ applicable enhanced features such as voice captions for photo viewings, advertisement widgets, auto video encoding process with thumbnail images, and viewing video playback on video player widget.

20. The multimedia widget application of claim 19, wherein the Personal Media Book deploys the complementary advertising widget at predetermined time and duration and video player widget when a video file is selected for playback.
